(19) United States
(12) Patent Application Publication
(10) Pub. No.: US 2005/0078693 A1
(43) Pub. Date: Apr. 14, 2005

(54) Time division multiplexed switch core using multiple write ports

(76) Inventors: Robert J. Landers, Allen, TX (US); David G. Caffo, Plano, TX (US)

Correspondence Address: TEXAS INSTRUMENTS INCORPORATED, P O BOX 655474, M/S 3999, DALLAS, TX, 75265, US

(21) Appl. No.: 10/683,038

(22) Filed: Oct. 10, 2003

(51) Int. Cl. H04L 12/56

(52) U.S. Cl. 370/412; 370/395.7

(57) ABSTRACT

ASIC libraries generally have some form of multi-port register file with 2 or more write ports and 2-8 read ports. Such register files can be exploited to implement a memory system using less external logic (fewer external-to-the memory MUXes to achieve desired narrow read ports) and/or fewer RAM instances. The desired memory system (including a single multi-port RAM that is configured to have a single very-wide write port and multiple narrow read ports) will then no longer require multiple instances of RAMs, and will therefore require less area due to overall reduced bit density.

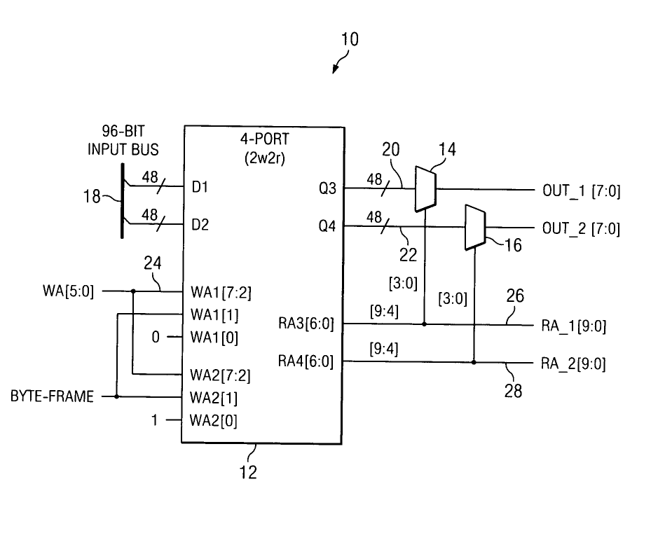

### BACKGROUND OF THE INVENTION

1. Field of the Invention

This invention relates generally to time division multiplexed (TDM) switches, and more particularly to a technique for providing a TDM switch core using multiple write ports.

2. Description of the Prior Art

The wide-write-port/narrow read-port requirement for time division multiplexed switches typically requires either a shallow, very wide memory that requires additional area for multiplexers (i.e. additional gates to multiplex the wide output bus down to an eight or sixteen-bit wide bus) to obtain the required narrow read-port, or requires a custom mixed read/write port width that results in additional development effort.

In view of the foregoing, it would be both beneficial and advantageous to provide a wide-write facility using only standard “off-the-shelf” register files. It would be further advantageous if the wide-write facility required less area and power than a comparable double-clocked single-port or two-port RAM solution, and was simpler to implement than the double-clocked single-port version.

### SUMMARY OF THE INVENTION

To meet the above and other objectives, the present invention provides a memory system employs a multi-port RAM that is configured to have a single very-wide write port and multiple narrow read ports. ASIC libraries generally have some form of multi-port register file with 2 or more write ports and 2-8 read ports. Such register files can be exploited to implement the desired memory system using less external logic (fewer external-to-the memory MUXes to achieve the desired narrow read ports) and/or fewer RAM instances. The desired memory system will then no longer require multiple instances of RAMs to build a memory system, and will therefore require less area due to overall reduced bit density.

According to one embodiment, a switch core comprises a memory unit having a plurality of write ports and a plurality of read ports; and a plurality of multiplexers, wherein the plurality of write ports are configured together to emulate a single wider write port capable of receiving data from multiple time-aligned sources, and further wherein the plurality of multiplexers are configured to access arbitrary memory unit inputs and time-slices via the plurality of read ports.

According to another embodiment, a switch core comprises a plurality of write ports and a plurality of read ports, wherein the plurality of write ports are configured together to emulate a single wider write port capable of receiving data from multiple time-aligned sources.

According to yet another embodiment, a method of writing and reading switch core data comprises the steps of configuring multiple write ports associated with a multi-port memory unit to emulate a single wider write port; writing data to the single wider write port from multiple time-aligned sources; and multiplexing memory unit read ports to access arbitrary input data and time slices from the memory unit.

### BRIEF DESCRIPTION OF THE DRAWINGS

Other aspects and features of the present invention and many of the attendant advantages of the present invention will be readily appreciated, as the invention becomes better understood by reference to the following detailed description when considered in connection with the accompanying drawing figure thereof and wherein:

The FIGURE is a schematic diagram illustrating a TDM switch core using multiple write ports according to one embodiment of the present invention.

While the above-identified drawing FIGURE sets forth a particular embodiments other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

As stated herein before, there is a need for a single very-wide write port and multiple narrow read ports*usually write width=N*read width, where N is the number of read ports required). The absolute minimum-area solution uses a custom-designed multi-port (1Wr×N Rd) RAM with wide write ports and narrow reads; but such specialty RAMs are rare in a typical ASIC library offering since this is a relatively small niche application. Further, development of custom RAMs is often prohibitive either in terms of schedule (takes too long to develop one by the time a customer ASIC project begins), or in terms of cost (the ROI may be too low to justify development of a custom memory without an existing customer to use it).

The present inventors alone recognized that in order to implement the required functionality without the aforementioned cost and schedule risks of custom design, existing ASIC memories must be used. Most ASIC libraries, as stated herein before, will have some form of multi-port register file with 2 or more write ports and 2-8 read ports.

Looking now at the figure, a memory system 10 is shown that includes a single 4-port (2-read+2-write) memory 12, a first read multiplexer 14 and a second read multiplexer 16. The memory system 10 can be seen to also have a wide 96-bit input data bus 18 and a pair of narrow 48-bit output busses 20, 22. Memory system 10 is further configured with a single wide write address port 24 and a pair of narrow read address ports 26, 28 that are operational to select the appropriate multiplexer 14, 16. The present invention is not so limited however, and it shall be understood that the principles set forth herein above can also be expanded to implement similar memory systems having even wider write ports and having even more narrow read ports, to further reduce the external logic device count and/or RAM instances.

In view of the above, it can be seen the present invention presents a significant advancement in the art of TDM switch core techniques. Further, this invention has been described in considerable detail in order to provide those skilled in the memory art with the information needed to apply the novel principles and to construct and use such specialized components as are required. In view of the foregoing descriptions, it should further be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

1. A switch core comprising:
a memory unit having a plurality of write ports and a plurality of read ports; and
a plurality of multiplexers, wherein the plurality of write ports are configured together to emulate a single wider write port capable of receiving data from multiple time-aligned sources, and further wherein the plurality of multiplexers are configured to access arbitrary memory unit inputs and time-slices via the plurality of read ports.

2. The switch core according to claim 1, wherein the memory unit comprises a multi-port random access memory.

3. A switch core comprising a plurality of write ports and a plurality of read ports, wherein the plurality of write ports are configured together to emulate a single wider write port capable of receiving data from multiple time-aligned sources.

4. The switch core according to claim 3, wherein the switch core comprises a multi-port random access memory.

5. The switch core according to claim 3, further comprising a plurality of multiplexers, wherein the plurality of multiplexers are configured to access arbitrary switch core inputs and time-slices via the plurality of read ports.

6. The switch core according to claim 5, wherein the switch core comprises a multi-port random access memory.

7. A method of writing and reading switch core data, the method comprising the steps of:
configuring multiple write ports associated with a multi-port memory unit to emulate a single wider write port;
writing data to the single wider write port from multiple time-aligned sources; and
multiplexing memory unit read ports to access arbitrary input data and time slices from the memory unit.
